(19) United States
(12) Patent Application Publication
(10) Pub. No.: US 2018/0010688 A1
(43) Pub. Date: Jan. 11, 2018

(54) COMPOSITE PISTON PIN AND MANUFACTURING METHOD OF THE SAME

(71) Applicants: Hyundai Motor Company, Seoul (KR); SK CHEMICALS CO., LTD, Seongnam-si (KR)

(72) Inventors: Sang Yoon PARK, Daejeon (KR); June Ho YANG, Seoul (KR); Sung Chul CHA, Seoul (KR); Chi Hoon CHOI, Suwon-si (KR); Seung Hyun HONG, Seoul (KR); Young Dae JO, Seoul (KR); Jae Won LEE, Yongin-si (KR)

(73) Assignees: Hyundai Motor Company, Seoul (KR); SK CHEMICALS CO., LTD., Seongnam-si (KR)

(21) Appl. No.: 15/353,536

(22) Filed: Nov. 16, 2016

(30) Foreign Application Priority Data
Jul. 11, 2016 (KR) 10-2016-0087327

(51) Int. Cl. F16J 1/16; B32B 37/14; B32B 5/02; B32B 38/00; B32B 27/38

(52) U.S. Cl. CPC F16J 1/16; B32B 38/0004; B32B 27/38; B32B 5/02; B32B 37/14; B32B 2305/076; B32B 2307/51

(57) ABSTRACT

Disclosed herein is a composite piston pin including a pipe-shaped outer layer made of reinforced fibers; an inner layer coupled to the outer layer along an inner surface of the outer layer, and made of reinforced fibers having lower elasticity than the outer layer; and a resin material including an epoxy resin composition and cyanate ester, and impregnated into the reinforced fibers of the outer layer and the inner layer.

### CROSS REFERENCE TO RELATED APPLICATION

The present application claims priority to Korean Patent Application No. 10-2016-0087327, filed Jul. 11, 2016, the entire contents of which is incorporated herein for all purposes by this reference.

### BACKGROUND OF THE INVENTION

### Field of the Invention

The present invention generally relates to a composite piston pin. More particularly, the present invention relates to a composite piston pin made of multi-layer pipe-shaped reinforced fibers having different elasticity, and a resin having high glass transition temperature and good formability.

### Description of Related Art

In the case of a piston pin constituted entirely of steel materials made of conventional SCM415 steel, when the piston pin is applied to a vehicle, mileage may not be improved because of the heavy weight thereof. Further, in terms of hoop directional flexural strength and longitudinal flexural strength required in the piston pin, material properties of the conventional piston pin are not satisfactory, so it is required to manufacture a piston pin to replace the conventional one.

For this reason, the present invention is intended to provide a composite piston pin made of carbon fiber having light weight and good rigidity.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Accordingly, the present invention has been made keeping in mind the above problems occurring in the related art. The present invention provides a composite piston pin made of multi-layer pipe-shaped reinforced fibers having different elasticity, and a resin having a high glass transition temperature and good formability.

In an aspect of the present invention, provided herein is a composite piston pin including: (1) a pipe-shaped outer layer made of reinforced fibers; (2) an inner layer coupled to the outer layer along an inner surface of the outer layer, and made of reinforced fibers having lower elasticity than the outer layer; and (3) a resin material including an epoxy resin composition and cyanate ester, and impregnated into the reinforced fibers of the outer layer and the inner layer.

The reinforced fibers of the outer layer and the inner layer may be made of carbon fibers, wherein the carbon fiber of the outer layer is a pitch-based carbon fiber, and the carbon fiber of the inner layer is a pan-based carbon fiber.

A mixture ratio of the epoxy resin composition and the cyanate ester may range from about 1:0.82 to about 1:1.22.

The epoxy resin composition may include a bisphenol A type (BPA type) epoxy and a phenol novolac epoxy.

The reinforced fibers of the outer layer may be arranged in parallel in a longitudinal direction of the outer layer. The inner layer may include: a first layer configured such that reinforced fibers thereof are arranged perpendicular to the reinforced fibers of the outer layer, the first layer being coupled to the outer layer along the inner surface of the outer layer; and a second layer configured such that reinforced fibers thereof are arranged in parallel to the reinforced fibers of the outer layer, the second layer being coupled to the first layer along an inner surface of the first layer.

Assuming that a total thickness of the outer layer and the inner layer is 100%, the thickness of the outer layer may be greater than 0% to about 50% (and not 0%) (e.g., about 1%, 5%, 10%, 15%, 20%, 25%, 30%, 35%, 40%, 45%, or about 50%), the thickness of the first layer of the inner layer may be from about 40% to about 80% (e.g., about 40%, 45%, 50%, 55%, 60%, 65%, 70%. 75%, or about 80%), and the thickness of the second layer of the inner layer may be from greater than 0% to about 60% (and not 0%) (e.g., about 1%, 5%, 10%, 15%, 20%, 25%, 30%, 35%, 40%, 45%, 50%, 55%, or about 60%).

According to another aspect of the present invention, there is provided a manufacturing method of a composite piston pin, the manufacturing method including: stacking a first prepreg constituted of a resin material including an epoxy resin composition and cyanate ester, and reinforced fibers, and a second prepreg constituted of a resin material including an epoxy resin composition and cyanate ester and reinforced fibers having lower elasticity than the reinforced fibers of the first prepreg; rolling the first prepreg and the second prepreg such that the first prepreg forms an outer surface; and integrally forming the first prepreg and the second prepreg rolled around the mold, in an oven.

After the rolling, the manufacturing method may further include wrapping a heat resistant film around an outer surface of the second prepreg.

After the forming, the manufacturing method may further include separating the heat resistant film and the mold from the first prepreg and the second prepreg and then cutting the first prepreg and the second prepreg into a predetermined length.

After the cutting, the manufacturing method may further include processing a surface of the first prepreg by grinding.

The composite piston pin of the present invention is advantageous in that it is configured such that the pin is formed in a multilayer structure. Also the reinforced fibers constituting the inner and the outer layers have different elasticity, and the resin material impregnated into the reinforced fibers includes an epoxy resin composition and cyanate ester, thereby improving bending strength as bending stress is reduced, and improving shearing strength as shearing stress is reduced.

The composite piston pin of the present invention is further advantageous in that the amount of oval deformation may be controlled.

Accordingly, it is possible to make the piston pin light in weight, and thus possible to improve mileage and durability by reducing friction.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the connection between elements of a composite piston pin according to an embodiment of the present invention.

FIG. 2 is a view showing glass transition temperature (Tg) by using a graph of storage modulus according to temperatures according to the embodiment of the present invention.

FIG. 3 is a view showing an area of the present invention by using a graph having three axes referring a first layer thickness, a second layer thickness, and an outer layer thickness.

FIG. 4 is a view showing comparison of bending stress among a comparative example, embodiment 1, and embodiment 2.

FIG. 5 is a view showing comparison of shearing stress among the comparative example, embodiment 1, and embodiment 2.

FIG. 6 is a view showing comparison of amount of oval deformation among the comparative example, embodiment 1, and embodiment 2.

FIG. 7 is a view showing first rolling and second rolling according to an embodiment of the present invention.

FIG. 8 is a view showing forming according to an embodiment of the present invention.

FIG. 9 is a view showing processing according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Herein below, exemplary embodiments of the present invention will be described in detail with reference to the accompanying drawings. Throughout the drawings, the same reference numerals will refer to the same or like parts.

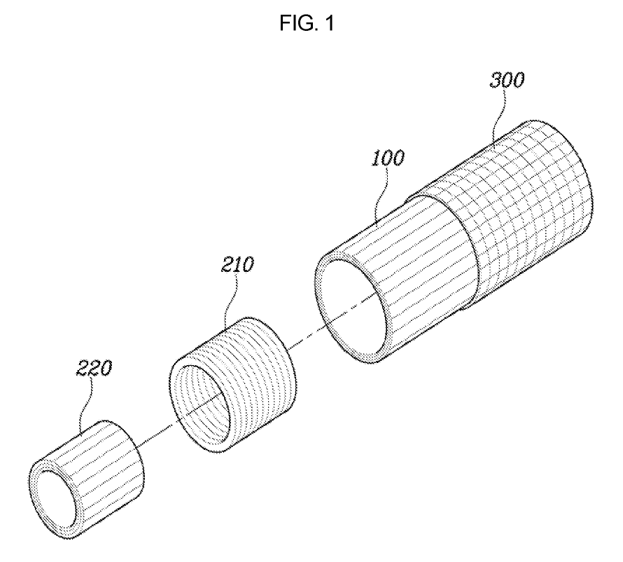

As shown in FIG. 1, a composite piston pin according to the present invention includes: a pipe-shaped outer layer 100 made of reinforced fibers; an inner layer 200 coupled to the outer layer 100 along an inner surface of the outer layer 100, and made of reinforced fibers having lower elasticity than the outer layer 100; and a resin material including an epoxy resin composition and cyanate ester, and impregnated into the reinforced fibers of the outer layer 100 and the inner layer 200.

The outer layer 100 is made of reinforced fibers, wherein the reinforced fibers may be made of at least one of carbon fiber, glass fiber, aramid fiber, and natural fiber. Further, the outer layer 100 is in a pipe-shape, and preferably, the outer layer is formed to be a pipe-shape by rolling sheet-shaped reinforced fibers.

The inner layer 200 is also made of reinforced fibers, wherein the reinforced fibers may be made of at least one of carbon fiber, glass fiber, aramid fiber, and natural fiber. Herein, the inner layer is made of reinforced fibers having lower elasticity than the outer layer 100.

The inner layer 200 is coupled to the outer layer 100 along the inner surface of the outer layer 100 to be in a pipe-shape, wherein the inner surface of the outer layer 100 having higher elasticity than the inner layer supports the outer layer 100 and bears a load applied thereto so as to improve hoop directional flexural strength.

The resin material improves heat resistance of the epoxy resin composition, and cyanate ester that improves flowability of resin is added thereto, so when the resin material is impregnated into the reinforced fibers, a void may be reduced and fiber uniformity of the reinforced fibers may be improved.

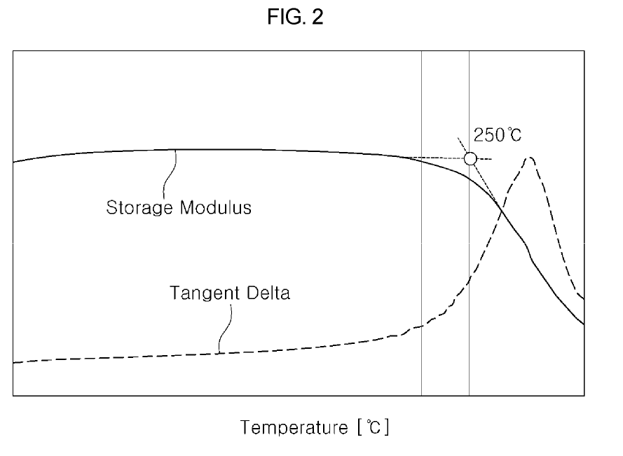

To be more specific, by adding cyanate ester, the glass transition temperature (Tg) rises, wherein the glass transition temperature (Tg) is the temperature at which polymers are changed from glassy state into rubbery state. This transition is called a glass transition, and as shown in a graph of FIG. 2, in the graph of the storage modulus to the temperature, the glass transition temperature (Tg) is shown as a point where a line extending from a low temperature meets a line extending from a high temperature. In the composite piston pin according to the present invention, the glass transition temperature (Tg) occurs at about 250° C.

Accordingly, the more the glass transition temperature (Tg) rises, the more the heat resistance is improved. In the resin material impregnated into the reinforced fibers, when the heat resistance is improved, plasticity does not occur dramatically in the forming process, and thereby the void may be reduced and fiber uniformity of the reinforced fibers may be improved.

However, when more cyanate ester is added in order to raise the glass transition temperature (Tg) for high heat resistance, viscosity of the resin material falls dramatically, and thereby it is difficult to manufacture a composite component having a uniform shape. Accordingly, a proper mixture ratio of the epoxy resin composition and the cyanate ester is required, which will be described hereinafter.

The resin material may include a catalyst as a metallic complex compound, cobalt acetylacetonate, and the like other than an epoxy resin composition and cyanate ester.

Preferably, in the resin material, a mixture ratio of the epoxy resin composition and the cyanate ester ranges from about 1:0.82 to about 1:1.22 (e.g., about 1:0.82, 1:0.9, 1:1, 1:1.1 or about 1:1.22). When the mixture ratio of the cyanate ester based on the epoxy resin composition is lower than 0.82, the glass transition temperature (Tg) falls, so when the resin material is impregnated into the reinforced fibers, many voids may occur and fiber uniformity of the reinforced fibers may be lowered.

On the contrary, when the mixture ratio of the cyanate ester is higher than 1.22, the resin material has poor formability due to high flowability, and viscosity of the resin material falls dramatically, and thereby it is difficult to manufacture a composite component having a uniform shape. Accordingly, the mixture ratio of the epoxy resin composition and the cyanate ester is limited within the range of from about 1:0.82 to about 1:1.22.

The reason and effect for limiting the range are shown in Table 1, herein below.

TABLE 1

| Mixture ratio | | Heat resistance | | | | | |
|---|---|---|---|---|---|---|---|
| | Mixture ratio of | Glass | | Formability | | Workability | |
| | cyanate ester to | transition | Criterion: | Resin | Criterion: | Viscosity | Criterion: |
| | epoxy resin | temperature | over | flowability | below | at 80° C. | 6000- |
| | composition | (Tg) (° C.) | 240° C. | (%) | 40% | (cps) | 20000 cps |
| Comparative | 0.43 | 219 | Fail | 21 | Pass | 13000 | Pass |
| example 1 | | | | | | | |
| Comparative | 0.67 | 224 | Fail | 25 | Pass | 11500 | Pass |
| example 2 | | | | | | | |
| Embodiment 1 | 0.82 | 246 | Pass | 28 | Pass | 10000 | Pass |
| Embodiment 2 | 1 | 250 | Pass | 34 | Pass | 8000 | Pass |
| Embodiment 3 | 1.22 | 258 | Pass | 40 | Pass | 6000 | Pass |
| Comparative | 1.5 | 263 | Pass | 43 | Fail | 4500 | Fail |
| example 3 | | | | | | | |

That the criterion of glass transition temperature (Tg) is set over 240° C. means that in the manufacturing process of the composite pin according to the present invention, the criterion of glass transition temperature is set according to temperatures of the oven when forming in the oven, and flowability of resin is evaluated by using melt flow index, wherein the higher melt flow index is, the better flowability of resin is. Both formability and workability are set by the level of easily manufacturing a composite component having a uniform shape.

Flowability means a numerical value of how far a fluid moves on a predetermined surface comparing to a reference material, so the larger the value is, the farther the fluid moves.

As shown in Table 1, when the mixture ratio of the cyanate ester to the epoxy resin composition is lower than 0.82, as shown the comparative example 1 and the comparative example 2, formability and workability are met but heat resistance is not met. When the mixture ratio of the cyanate ester to the epoxy resin composition is higher than 1.22, as shown the comparative example 3, heat resistance is met but formability and workability are not met.

The epoxy resin composition may include a bisphenol A type (BPA type) epoxy and a phenol novolac epoxy. Preferably, BPA type epoxy accounts for 10-40% of 100% of the entire epoxy resin composition, and the rest is phenol Novolac epoxy accounting for 60-90%.

Meanwhile, the reinforced fibers of the outer layer 100 and the inner layer 200 may be made of carbon fibers, wherein the carbon fiber of the outer layer 100 is a pitch-based carbon fiber, and the carbon fiber of the inner layer 200 is a pan-based carbon fiber.

The pitch-based carbon fiber, which has modulus of elasticity of over about 640 GPa, generally has high elasticity since the carbon percentage is high, and thereby it is possible to prevent oval deformation causing deformation of the pin resulting from weight when weight is loaded thereon, and also prevent flexural deformation by improving hoop directional flexural strength and material strength.

The pan-based carbon fiber, which has modulus of elasticity of over about 240 GPa, generally has high compressive strength, and thereby is disposed at the innermost side of the composite piston pin so as to support the outer layer 100 and to bear a load placed thereon, and accordingly hoop directional flexural strength is improved. Thereby, it is possible to prevent oval deformation caused by load. The cost of the pan-based carbon fiber is low, so it is possible to reduce manufacturing cost.

The reinforced fibers of the outer layer 100 may be arranged in parallel in a longitudinal direction of the outer layer, and the inner layer 200 may include: a first layer 210 configured such that reinforced fibers thereof are arranged perpendicular to the reinforced fibers of the outer layer 100, the first layer being coupled to the outer layer 100 along the inner surface of the outer layer 100; and a second layer 220 configured such that reinforced fibers thereof are arranged in parallel to the reinforced fibers of the outer layer 100, the second layer being coupled to the first layer 210 along an inner surface of the first layer 210.

The reinforced fibers of the outer layer 100 are arranged in parallel in a longitudinal direction of the outer layer. The inner layer 200, which is formed in a multilayer structure, is configured such that: the first layer 210 coupled to the inner surface of the outer layer 100 is configured such that reinforced fibers thereof are arranged perpendicular to the reinforced fibers of the outer layer 100; the second layer 220 coupled to the inner surface of the first layer 210 is configured such that reinforced fibers thereof are arranged in parallel to the reinforced fibers of the outer layer 100, and consequently, the reinforced fibers of the outer layer 100, the first layer 210, and the second layer 220 have fiber orientations of 0°, 90°, and 0° degrees from the outer layer.

Thereby, it is possible to improve rigidity of the composite piston pin, and is possible for the piston pin to bear a load in a width direction of the composite piston pin as well as in a longitudinal direction thereof.

The outer surface of the outer layer 100 is wrapped with plain weave 300 so as to prevent separation of the fiber.

More preferably, assuming that a total thickness of the outer layer 100 and the inner layer 200 is 100%, the outer layer 100 accounts for 0% to 50%, the first layer 210 accounts for 40% to 80%, and the second layer 220 accounts for 0% to 60%.

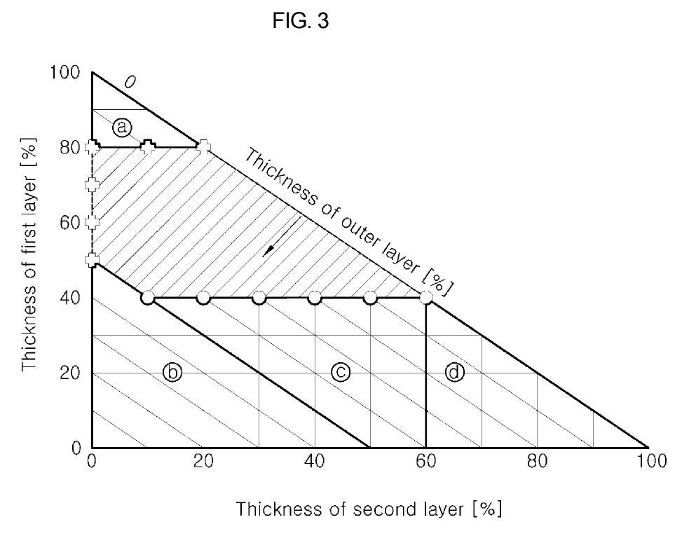

As shown in FIG. 3, in the case of an upper part of the right-angled triangle as area \textcircled{a}, since the thickness of the first layer 210 is over 80% based on the entire thickness, the percentage of the first layer 210 is high, so bending strength of the pin is reduced, and thereby oval deformation and flexural deformation occur.

In the case of a lower left part of the right-angled triangle as area \textcircled{b}, since the thickness of the outer layer 100 is over 50%, or the thickness of the first layer 210 is below 40% based on the entire thickness, the percentage of the outer layer 100 is high, so shearing strength of the pin is reduced, and thereby oval deformation occurs.

In the case of a lower center part of the right-angled triangle as area \textcircled{c}, since the thickness of the first layer 210 is below 40% based on the entire thickness, the percentage of the second layer 220 is high, so shearing strength and material strength of the pin are reduced, and thereby oval deformation and flexural deformation occur.

In the case of a lower right part of the right-angled triangle as area \textcircled{d}, since the thickness of the second layer 220 is over 60%, or the thickness of the first layer 210 is below 40% based on the entire thickness, the percentage of the second layer 220 is high, so shearing strength and material strength of the pin are reduced, and thereby oval deformation and flexural deformation occur.

Accordingly, assuming that a total thickness of the outer layer 100 and the inner layer 200 is 100%, it is exemplary that the outer layer 100 accounts for 0˜50%, the first layer 210 accounts for 40% to 80%, and the second layer 220 accounts for 0% to 60%.

The composite piston pin according to the present invention is formed in a multilayer structure, wherein the reinforced fibers constituting the inner and the outer layers have different elasticity, and the resin material impregnated into the reinforced fibers includes an epoxy resin composition and cyanate ester.

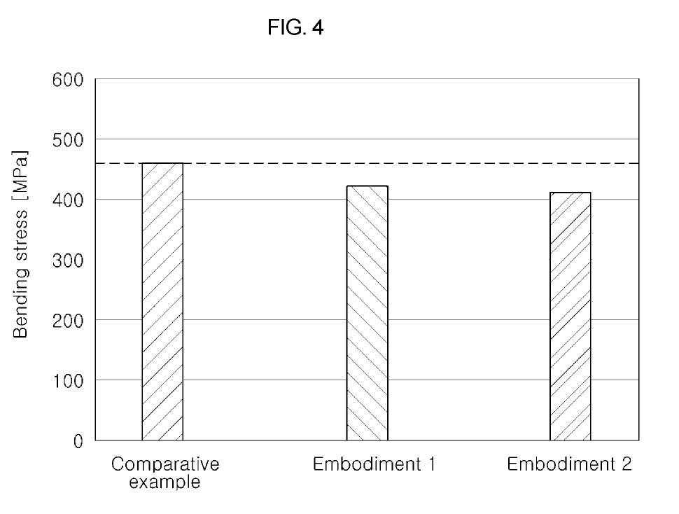

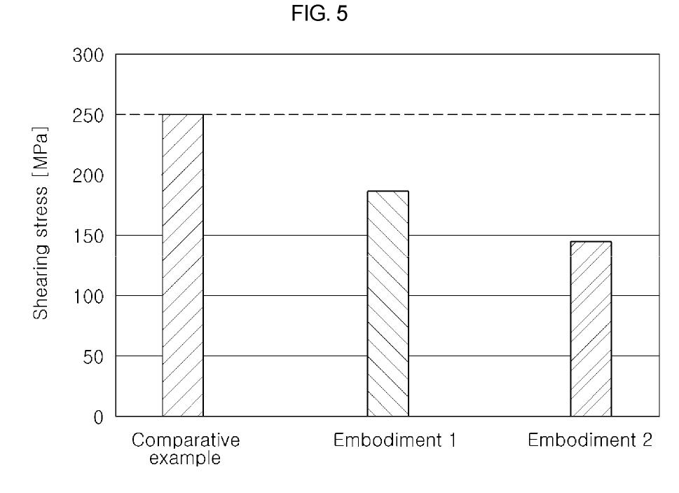

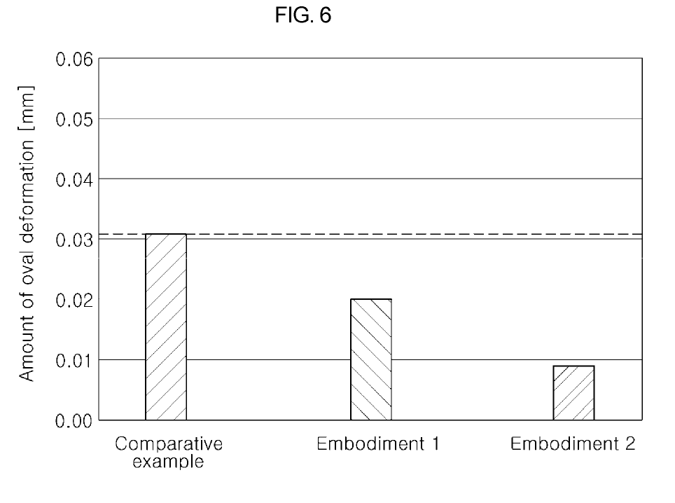

FIG. 4, FIG. 5 and FIG. 6 are graphs showing comparison of material properties among a SCM415 pin made of a conventional metal material and weighing about 79 g, embodiment 1 as a pin according to the embodiment of the present invention weighing about 20 g, and embodiment 2 weighing about 23 g.

As shown a graph of FIG. 4, bending stress is reduced by about 8% to 10% compared to the conventional SCM415 pin, so bending strength is improved, and as shown a graph of FIG. 5, shearing stress is reduced by about 25% to 41% compared to the conventional SCM415 pin, so shearing strength is improved. Further, the amount of oval deformation, as shown in a graph of FIG. 6, is reduced by about 36% to 72% compared to the conventional SCM415 pin.

The composite piston pin according to the present invention may be used as a component enduring friction and wear in an engine, in a valve train of a transmission, in a shaft, and the like. To be specific, the composite piston pin may be used for a rocker arm pin, a CVVL pin, a swing arm pin, a timing chain pin, a tappet, a pin or a shaft of a transmission, and the like, but not limited thereto.

A manufacturing method of a composite piston pin according to the present invention includes: first rolling a first prepreg 10 constituted of a resin material including an epoxy resin composition and cyanate ester, and reinforced fibers such that the first prepreg 10 surrounds an outer surface of a cylindrical mold 30; second rolling a second prepreg 20 constituted of a resin material including an epoxy resin composition and cyanate ester, and reinforced fibers having higher elasticity than the reinforced fibers of the first prepreg 10 such that the second prepreg 20 surrounds an outer surface of the first prepreg 10; and integrally forming the first prepreg 10 and the second prepreg 20 rolled around the mold 30, in an oven.

Preferably, after the rolling step, the manufacturing method further includes wrapping a heat resistant film around an outer surface of the second prepreg 20.

Firstly, the first prepreg 10 constituted of the reinforced fibers having relatively low elasticity is surrounded around the outer surface of the cylindrical mold 30 through the first rolling. The sheet-shaped first prepreg 10 having a predetermined width is widely spread, then the mold 30 is located at an end of the first prepreg, and the first prepreg 10 is rolled to surround the outer surface of the mold 30.

Next, the second prepreg 20 constituted of the reinforced fibers having relatively high elasticity is surrounded around the outer surface of the first prepreg 10 through the second rolling. The sheet-shaped second prepreg 20 having a predetermined width is widely spread, then the mold 30 having been surrounded by the first prepreg 10 is located at an end of the second prepreg, and the second prepreg 20 is rolled to surround the outer surface of the first prepreg 10.

Through the first rolling and the second rolling steps, the second prepreg 20 constituted of the reinforced fibers having relatively high elasticity is located at the outer layer, and the first prepreg 10 constituted of the reinforced fibers having relatively low elasticity is located at the inner layer.

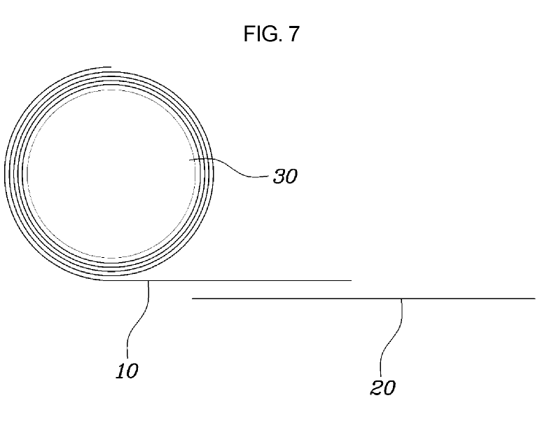

Preferably, as shown in FIG. 7, the first prepreg 10 and the second prepreg 20 are widely spread, wherein an end of the first prepreg 10 and an end of the second prepreg 20 are connected to be overlapped with each other, and then the first prepreg 10 and the second prepreg 20 are rolled by using the mold 30.

Further, in the composite piston pin, the thickness of the inner layer 200 and the thickness of the outer layer 100 can be adjusted by changing the length of the first prepreg 10 and the length of the second prepreg 20.

After the second rolling step, the heat resistant film is wrapped around the outer surface of the second prepreg 20. The film may be constituted of a heat shrinkable tape with heat resistance.

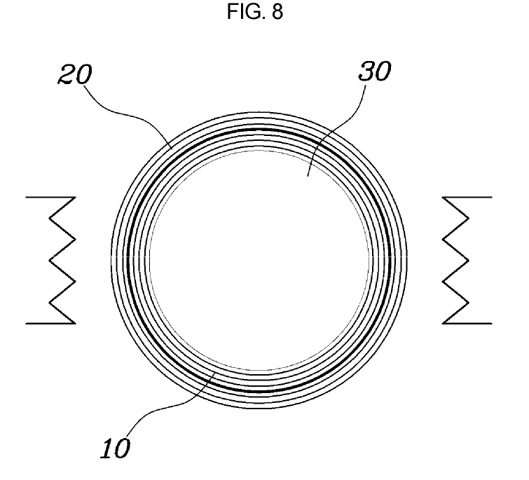

After then, as shown in FIG. 8, the first prepreg 10 and the second prepreg 20 wrapped by the film are integrally formed in an oven. By wrapping the heat resistant film around the outer surface of the second prepreg 20, when forming the prepreg in the oven, the heat resistant film is shrunk by heat, and thereby it is possible to remove blow holes in the first prepreg 10 and the second prepreg 20.

The forming step in the oven may be lasted for about an hour at a temperature of 200˜250° C. The resin material includes cyanate ester, so heat resistance is improved. Thereby, plasticity does not occur dramatically in the forming process in the oven, and accordingly the void may be reduced and fiber uniformity of the reinforced fibers may be improved.

After the forming step, the manufacturing method may further include separating the heat resistant film and the mold 30 from the first prepreg 10 and the second prepreg 20, and then cutting the first prepreg and the second prepreg into a predetermined length. Further, after the cutting, the manufacturing method may include processing a surface of the second prepreg 20 by grinding.

The first prepreg 10 and the second prepreg 20 are taken out from the oven after the forming, then the heat resistant film wrapped around the outer surface of the second prepreg 20 is removed, the mold 30 surrounded by the first prepreg 10 is separated, and then the first prepreg 10 and the second prepreg 20 are cut for a specific purpose.

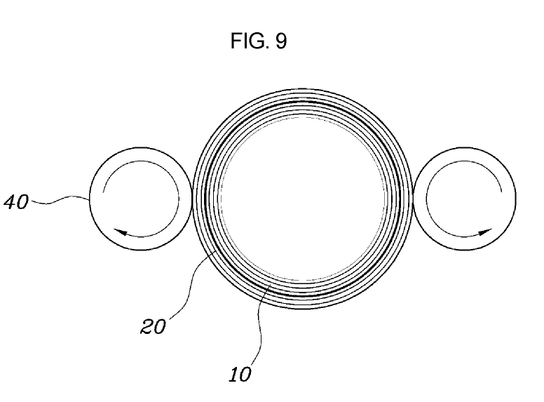

In order to process the first prepreg 10 and the second prepreg 20 having been cut, the surface of the first prepreg is ground by using a grinder 40, such as grinding stones, and the like. Preferably, as shown in FIG. 9, a pair of grinding stones rotating in an opposite direction with each other is rotated while coming into contact with the outer surface of the second prepreg 20 such that the surface of the second prepreg 20 is ground.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A composite piston pin comprising:
a pipe-shaped outer layer made of reinforced fibers;
an inner layer coupled to the outer layer along an inner surface of the outer layer, and made of reinforced fibers having lower elasticity than the outer layer; and
a resin material comprising an epoxy resin composition and cyanate ester, and impregnated into the reinforced fibers of the outer layer and the inner layer.

2. The composite piston pin of claim 1, wherein
a mixture ratio of the epoxy resin composition and the cyanate ester ranges from about 1:0.82 to about 1:1.22.

3. The composite piston pin of claim 2, wherein
the epoxy resin composition comprises a bisphenol A type (BPA type) epoxy and a phenol novolac epoxy.

4. The composite piston pin of claim 1, wherein
the reinforced fibers of the outer layer and the inner layer are made of carbon fibers, wherein
the carbon fiber of the outer layer is a pitch-based carbon fiber, and the carbon fiber of the inner layer is a pan-based carbon fiber.

5. The composite piston pin of claim 1, wherein
the reinforced fibers of the outer layer are arranged in parallel in a longitudinal direction of the outer layer, and
the inner layer comprises:
a first layer configured such that reinforced fibers thereof are arranged perpendicular to the reinforced fibers of the outer layer, the first layer being coupled to the outer layer along the inner surface of the outer layer; and
a second layer configured such that reinforced fibers thereof are arranged in parallel to the reinforced fibers of the outer layer, the second layer being coupled to the first layer along an inner surface of the first layer.

6. The composite piston pin of claim 5, wherein
assuming that a total thickness of the outer layer and the inner layer is 100%, the thickness of the outer layer is from greater than 0% to about 50% or the total, the thickness of the first layer is from about 40% to about 80% of the total, and the thickness of the second layer is from greater than 0% to about 60% of the total.

7. A manufacturing method of a composite piston pin, the manufacturing method comprising:
first rolling a first prepreg constituted by a resin material comprising an epoxy resin composition and cyanate ester, and reinforced fibers such that the first prepreg surrounds an outer surface of a cylindrical mold;
second rolling a second prepreg constituted by a resin material comprising an epoxy resin composition and cyanate ester, and reinforced fibers having higher elasticity than the reinforced fibers of the first prepreg such that the second prepreg surrounds an outer surface of the first prepreg; and
integrally forming the first prepreg and the second prepreg rolled around the mold, in an oven.

8. The manufacturing method of claim 7, further comprising:
after the second rolling, wrapping a heat resistant film around an outer surface of the second prepreg.

9. The manufacturing method of claim 8, further comprising:
after the forming, separating the heat resistant film and the mold from the first prepreg and the second prepreg, and cutting the first prepreg and the second prepreg into a predetermined length.

10. The manufacturing method of claim 9, further comprising:
after the cutting, processing a surface of the second prepreg by grinding.
